(19) United States
(12) Patent Application Publication
(10) Pub. No.: US 2025/0273896 A1
(43) Pub. Date: Aug. 28, 2025

(54) CONNECTOR AND CONNECTOR DISASSEMBLY TOOL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Yasunori ASANO, Mie (JP)

(21) Appl. No.: 18/856,887

(22) PCT Filed: Apr. 3, 2023
(86) PCT No.: PCT/JP2023/013809

§ 371 Date: Oct. 15, 2024

(30) Foreign Application Priority Data
Apr. 22, 2022 (JP) 2022-070542

(51) Int. Cl. H01R 13/436; H01R 43/22

(52) U.S. Cl. CPC H01R 13/4361; H01R 43/22

(57) ABSTRACT

A connector includes a terminal and a connector housing including a housing body having a cavity and a retainer to be removably mounted into the housing body. The housing body includes a cavity exposing recess, a pair of retainer guide grooves and a pair of locking portion respectively formed on bottom surfaces of the pair of retainer guide grooves. The retainer includes a retainer body for holding the terminal in the cavity, a pair of retainer side portions extending along the pair of retainer guide grooves and a pair of mating locking portions respectively formed on the pair of retainer side portions. A pair of recessed grooves are formed to extend from positions of the housing body where the pair of locking portions are respectively formed toward at least one end of the housing body.

### TECHNICAL FIELD

The present disclosure relates to a connector and a connector disassembly tool.

### BACKGROUND

Patent Document 1 discloses a terminal pull-out jig used for a connector including an upper terminal held by a lance mechanism and upper and lower guide projections located closer to an opening side than the upper terminal. The terminal pull-out jig includes a jig body and a release pin. It is disclosed to release the lance mechanism by inserting a tip side of the jig body into an outer housing of the connector and turning the release pin facing the lance mechanism about a center axis of the jig body.

### PRIOR ART DOCUMENT

### Patent Document

Patent Document 1: JP 2018-170108 A

### SUMMARY OF THE INVENTION

### Problems to be Solved

There is known a connector in which a retainer is mounted into a housing body and a terminal is held by this retainer. Also in the connector in which the terminal is held by the retainer in this way, it is requested to make a state of holding the terminal by the retainer easily releasable.

Accordingly, the present disclosure aims to make a state of holding a terminal by a retainer easily releasable.

### Means to Solve the Problem

The present disclosure is directed to a connector with a terminal and a connector housing including a housing body having a cavity extending from one end toward the other end and a retainer to be removably mounted into the housing body, the terminal being accommodated into the cavity, the housing body including a cavity exposing recess for exposing an intermediate part in an extension direction of the cavity to outside, a pair of retainer guide grooves formed in both side parts of the housing body to extend in a direction intersecting the extension direction of the cavity from both side parts of the cavity exposing recess and a pair of locking portions respectively formed on bottom surfaces of the pair of retainer guide grooves, the retainer including a retainer body to be arranged in the cavity exposing recess to hold the terminal in the cavity, a pair of retainer side portions extending from both side parts of the retainer body along the pair of retainer guide grooves and a pair of mating locking portions respectively formed on the pair of retainer side portions and lockable to the locking portions, and a pair of recessed grooves being formed to extend from positions of the housing body where the pair of locking portions are respectively formed toward at least one end of the housing body.

The present disclosure is also directed to a connector disassembly tool for releasing a locked state of a retainer to a housing body, the connector disassembly tool being provided with a pair of unlocking portions formed into a long shape and a disassembly tool body for supporting the pair of unlocking portions such that the pair of unlocking portions are kept in a parallel state corresponding to locking parts of both side parts of the housing body and the retainer, each of the pair of unlocking portions including a tip portion gradually thinned toward a tip to be insertable between the retainer and the side part of the housing body.

### Effect of the Invention

According to the present disclosure, a state of holding a terminal by a retainer can be easily released.

### BRIEF DESCRIPTION OF THE DRAWINGS

FIG. 1 is a perspective view showing a connector according to an embodiment.

FIG. 2 is a perspective view showing the connector having a retainer removed therefrom.

FIG. 3 is a section along III-III of FIG. 1.

FIG. 4 is a section along IV-IV of FIG. 1.

FIG. 5 is a perspective view showing a connector disassembly tool according to the embodiment.

FIG. 6 is a perspective view showing the connector disassembly tool.

FIG. 7 is a view showing a disassembly operation example of the connector.

FIG. 8 is a diagram showing the disassembly operation example of the connector.

FIG. 9 is a diagram showing the disassembly operation example of the connector.

FIG. 10 is a diagram showing a connector disassembly tool according to a modification.

FIG. 11 is a diagram showing a connector according to a modification.

### DETAILED DESCRIPTION TO EXECUTE THE INVENTION

### Description of Embodiments of Present Disclosure

First, embodiments of the present disclosure are listed and described.

The connector of the present disclosure is as follows.
(1) The connector of the present disclosure is provided with a terminal and a connector housing including a housing body having a cavity extending from one end toward the other end and a retainer to be removably mounted into the housing body, the terminal being accommodated into the cavity, the housing body including a cavity exposing recess for exposing an intermediate part in an extension direction of the cavity to outside, a pair of retainer guide grooves formed in both side parts of the housing body to extend in a direction intersecting the extension direction of the cavity from both side parts of the cavity exposing recess and a pair of locking portions respectively formed on bottom surfaces of the pair of retainer guide grooves, the retainer including a retainer body to be arranged in the cavity exposing recess to hold the terminal in the cavity, a pair of retainer side portions extending from both side parts of the retainer body along the pair of retainer guide grooves and a pair of mating locking portions respectively formed on the pair of retainer side portions and lockable to the locking portions, and a pair of recessed grooves being formed to extend from positions of the housing body where the pair of locking portions are respectively formed toward at least one end of the housing body.

According to this connector, utilizing spaces in the pair of recessed grooves, the locking of the locking portions and the mating locking portions is easily released by moving the pair of retainer side portions in a direction separating from the side portions of the housing body and the retainer is easily moved in a direction separating from the cavity exposing recess. In this way, a state of holding the terminal by the retainer can be easily released.
(2) In the connector of (1), the pair of recessed grooves may be respectively grooves extending from the positions of the housing body where the pair of locking portions are respectively formed toward both ends of the housing body.

In this way, the state of holding the terminal by the retainer can be easily released, utilizing the recessed grooves extending from the positions of the housing body where the pair of locking portions are respectively formed toward the both ends of the housing body.
(3) In the connector of (1) or (2), a slit extending along the extension direction of the cavity may be formed in an inward facing part of the retainer body, and the retainer body may include a partially thinned portion outside the slit.

In this case, since the retainer body includes the partially thinned portion, an inward facing surface of a part where the thinned portion is formed is easily located more outward than the outward facing surface of the housing body even if a moving distance of the retainer in the direction separating from the cavity exposing recess is short. In this way, the retainer is more easily moved in the direction separating from the cavity exposing recess.
(4) In the connector of (3), at least one edge of the part of the retainer body where the thinned portion is formed may be partially recessed in an extension direction of the retainer guide grooves.

In this case, for example, when the retainer is removed by moving a connector disassembly tool along the retainer guide grooves, it is possible to adjust a contact timing of the connector disassembly tool with at least one edge of the part of the retainer body where the thinned portion is formed.
(5) In the connector of any one of (1) to (4), the housing body may have a principal surface located on an extension of an outward facing surface of the retainer body and a pair of side surfaces located on extensions of outward facing surfaces of the pair of retainer side portions in a mounted state of the retainer.

In this way, the connector disassembly tool for removing the retainer is easily handled outside the principal surface and the pair of side surfaces.
(6) In the connector of any one of (1) to (5), the housing body may include a plurality of cavities arranged in a row extending from one side toward the other side of the retainer body.

In this case, the retainer is easily separated from the housing body as compared to the case where the cavities are arranged in a plurality of rows.
(7) In the connector of any one of (1) to (5), the housing body may include a plurality of cavities arranged in a plurality of rows extending from one side toward the other side of the retainer body at positions different in a direction along the retainer guide grooves, the housing body may include a plurality of the cavity exposing recesses in correspondence with the respective rows of the plurality of cavities, and the retainer may include a plurality of the retainer bodies in correspondence with the respective rows of the plurality of cavities.

In this way, the state of holding the terminals by the retainer body is collectively released in each row of the plurality of cavities.

Further, the connector disassembly tool of the present disclosure is as follows.
(8) The connector disassembly tool of the present disclosure is for releasing a locked state of a retainer to a housing body, and provided with a pair of unlocking portions formed into a long shape and a disassembly tool body for supporting the pair of unlocking portions such that the pair of unlocking portions are kept in a parallel state corresponding to locking parts of both side parts of the housing body and the retainer, each of the pair of unlocking portions including a tip portion gradually thinned toward a tip to be insertable between the retainer and the side part of the housing body.

According to this connector disassembly tool, the tip portions of the pair of unlocking portions can be inserted between the retainer and the side parts of the housing body by moving the pair of unlocking portions along the both side parts of the housing body. In this way, the locked state of the retainer to the housing body can be released and the state of holding the terminal by the retainer can be easily released.
(9) In the connector disassembly tool of (8), the tip portion of the unlocking portion may have a contact receiving surface to be held in contact with a bottom surface and one side surface of a recessed groove formed in the side part of the housing body when the unlocking portion moves along the side part of the housing body and a separating/lifting surface located on a side opposite to the contact receiving surface and gradually separating from the bottom surface and the one side surface of the recessed groove toward a base end side.

In this case, if the unlocking portion moves in the recessed groove, the separating/lifting surface can move the retainer in a direction separating from the bottom surface and the one side surface of the recessed groove. In this way, the locked state of the retainer to the housing body can be released, the retainer can be moved in the direction separating from the housing body and the state of holding the terminal by the retainer can be easily released.
(10) The connector disassembly tool of (8) or (9) may be further provided with an additional lifting portion supported by the disassembly tool body to extend in the same direction as an extension direction of the pair of unlocking portions, and the additional lifting portion may enter between the retainer and the housing body to move the retainer in a direction separating from the housing body at a position between the pair of unlocking portions with the tip portions of the pair of unlocking portions inserted between the retainer and the side parts of the housing body.

In this case, since the retainer body can be further lifted up in the direction separating from the cavity exposing recess by the additional lifting portion, the connector is more easily disassembled.
(11) In the connector disassembly tool of any one of (8) to (10), the disassembly tool body may be formed into a shape to surround at least a part of a periphery of the housing body while avoiding interference with the housing body when the pair of unlocking portions move along a pair of recessed grooves formed in the both side parts of the housing body.

In this way, the pair of unlocking portions are easily moved along the pair of recessed grooves. If the recessed grooves penetrate between both ends of the housing body, the pair of locking portions can be set to pass through the pair of recessed grooves and a disassembly operation of the connector is easily performed.
(12) The connector disassembly tool of any one of (8) to (11) may be further provided with a grip portion projecting from the disassembly tool body.

In this way, since a force is easily applied to the connector disassembly tool, the disassembly operation of the connector can be easily performed.

### Details of Embodiment of Present Disclosure

Specific examples of a connector and a connector disassembly tool of the present disclosure are described below with reference to the drawings. Note that the present disclosure is not limited to these illustrations, but is represented by claims and intended to include all changes in the scope of claims and in the meaning and scope of equivalents.

### Embodiment

Hereinafter, after a connector according to an embodiment is described, a connector disassembly tool for disassembling the connector is described.

### <Connector>

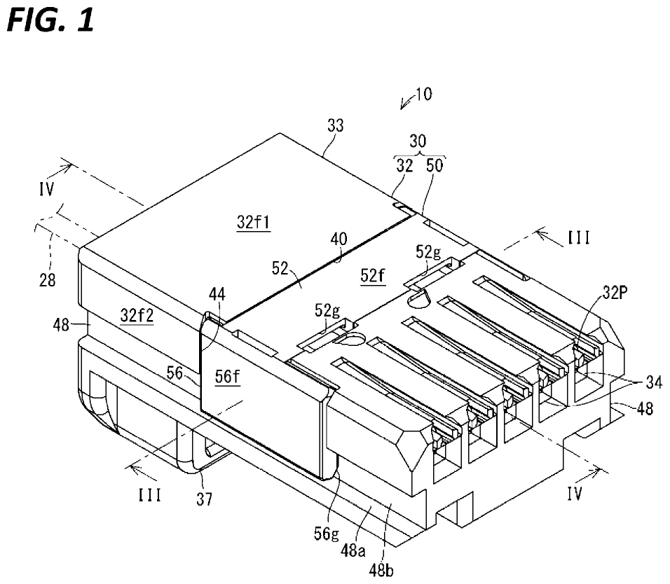

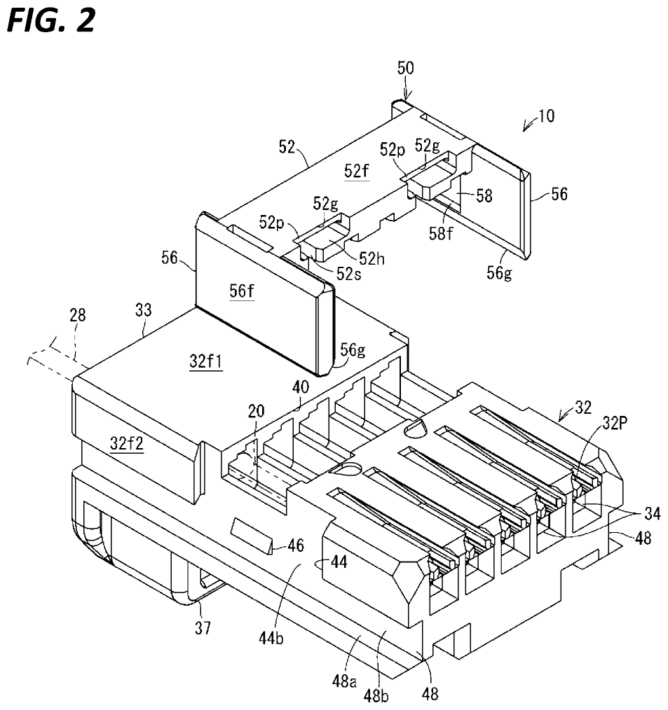

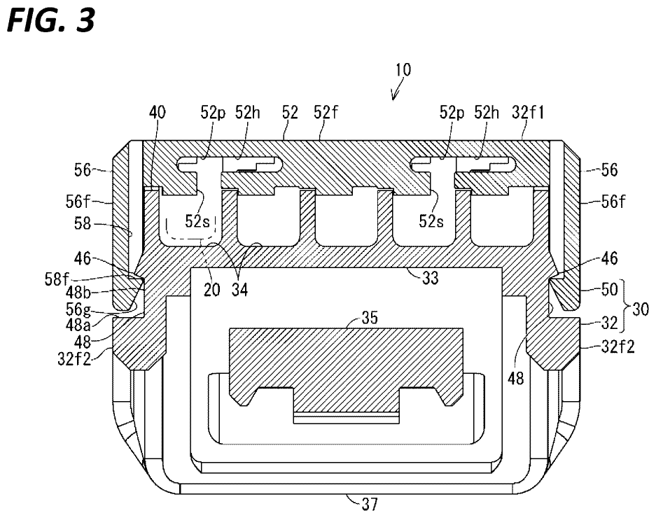

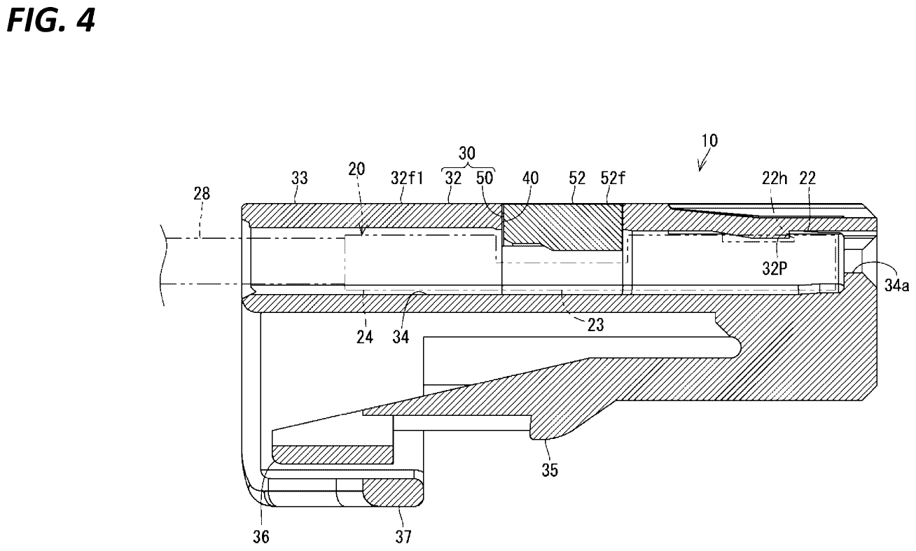

FIG. 1 is a perspective view showing a connector 10. FIG. 2 is a perspective view showing the connector 10 having a retainer 50 removed therefrom. FIG. 3 is a section along III-III of FIG. 1. FIG. 4 is a section along IV-IV of FIG. 1. In FIGS. 1 to 4, terminals 20 and wires 28 are shown by two-dot chain lines. In FIGS. 1 to 3, some terminals 20 or some wires 28 are shown.

The connector 10 is provided with the terminals 20 and a connector housing 30.

The terminal 20 is formed, such as by press-working a metal plate material of copper, copper alloy or the like. The terminal 20 is formed such that a mating connecting portion 22 and a wire connecting portion 24 are linearly connected via a coupling portion 23.

The mating connecting portion 22 is a part to be connected to a mating terminal or the like. Here, the mating connecting portion 22 has a rectangular tube shape, i.e. a so-called female terminal shape. A mating terminal (so-called male terminal) including a pin-like or tab-like connecting portion is inserted and connected to this mating connecting portion 22. Of course, the mating connecting portion 22 may be formed to have a pin-like or tab-like shape, i.e. a so-called male terminal shape. In the case of a male terminal, a box portion is formed in a base end part of a pin-like or tab-like part.

The wire connecting portion 24 is a part to be crimped to an end part of the wire 28 and connected to the wire 28. The wire connecting portion 24 includes, for example, a core wire crimping portion and a coating crimping portion. Of course, the coating crimping portion may be possibly omitted in the wire connecting portion 24.

The core wire crimping portion is shaped such that a pair of crimping pieces rise from both side parts of a bottom plate portion. The pair of crimping pieces are bent inward with a core wire exposed in the end part of the wire 28 disposed in the core wire crimping portion. In this way, the core wire crimping portion is crimped to the exposed core wire.

The coating crimping portion is also shaped such that a pair of crimping pieces rise from both side parts of a bottom plate portion. The pair of crimping pieces are bent inward with an end part of an insulation coating of the wire 28 disposed in the coating crimping portion. In this way, the coating crimping portion is crimped to the end part of the insulation coating.

A bottom part of the mating connecting portion 22 and that of the wire connecting portion 24 are coupled via the coupling portion 23. Thus, the bottom part of the mating connecting portion 22, the coupling portion 23 and the bottom part of the wire connecting portion 24 are connected on the same straight line. The mating connecting portion 22 and the wire connecting portion 24 project from the coupling portion 23. In other words, the terminal 20 is shaped to be recessed toward a bottom side between the mating connecting portion 22 and the wire connecting portion 24. By fitting the retainer 50 into a recess between the mating connecting portion 22 and the wire connecting portion 24, the terminal 20 can be held at a fixed position in the connector housing 30.

The connector housing 30 includes a housing body 32 and the retainer 50.

The housing body 32 is a component including cavities 34 extending from one end toward the other end and configured to accommodate the terminals 20 in the cavities 34. The housing body 32 is a component molded, using a resin or the like. With the terminals 20 accommodated in the housing body 32, the connector housing 30 is connected to a mating connector (not shown). In this way, the terminals 20 are connected to the mating terminals accommodated in the mating connector.

More specifically, the housing body 33 includes a flat rectangular parallelepiped part 33. The cavities 34 are formed to extend from one end toward the other end of the rectangular parallelepiped part 33. The cavity 34 is a through hole open in the one end and the other end of the rectangular parallelepiped part 33. The cavity 34 is longer than the terminal 20, and the entire terminal 20 in an extension direction is accommodated in the cavity 34. The wire 28 is pulled out from an opening on the one end side of the cavity 34. The mating terminal is inserted through an opening on the other end side of the cavity 34. For the convenience of description, a side of the connector 10 where the wires 28 extend out and an opposite side thereof may be referred to as a rear side and a front side.

In this embodiment, the housing body 32 includes a plurality of the cavities 34. The plurality of cavities 34 are formed side by side in parallel in a row from one side to the other side of the housing body 32 (here, the rectangular parallelepiped part 33). By accommodating the terminals 20 respectively into the plurality of cavities 34, a plurality of the terminals 20 are arranged in parallel in a row.

The retainer 50 is removably mounted into the housing body 32. Here, a direction orthogonal to both an extension direction of the plurality of cavities 34 and an arrangement direction of the plurality of cavities 34 is grasped as a thickness direction of the housing body 32. The retainer 50 is removably mounted on one surface side in the thickness direction of the housing body 32.

Note that, in this embodiment, the housing body 32 is provided with a connector connecting locking piece 35 removably locked to the mating connector (see FIG. 3). The connector connecting locking piece 35 is provided on a side opposite to the retainer 50 with respect to the rectangular parallelepiped part 33.

Further, the housing body 32 is provided with an operating portion 36 for pushing down the connector connecting locking piece 35 and a surrounding portion 37 surrounding the operating portion 36 (see FIG. 3).

With this connector 10 connected to the mating connector, the connector connecting locking piece 35 is locked to the mating connector to maintain a connected state of the both connectors. Further, by pushing down the operating portion 36 in this state, a locked state of the connector connecting locking piece 35 and the mating connector is released and a connected state of the both connectors is released. The surrounding portion 37 functions to suppress the connector connecting locking piece 35 from being inadvertently pushed down by surrounding the operating portion 36.

The connector connecting locking piece 35, the operating portion 36 and the shape example of the operating portion 36 in the connector 10 need not be those described above or these components may be omitted.

The housing body 32 includes a cavity exposing recess 40, retainer guide grooves 44 and a pair of locking portions 46.

The cavity exposing recess 40 is a recess for exposing intermediate parts in the extension direction of the cavities 34 to outside. In this embodiment, the cavity exposing recess 40 is formed to extend in the arrangement direction of the plurality of cavities 34 on the one surface side in the thickness direction of the rectangular parallelepiped part 33. The cavity exposing recess 40 extends in a direction intersecting (here, a direction orthogonal to) the extension direction of the plurality of cavities 34 and crosses the intermediate parts in the extension direction of the cavities 34. Thus, the insides of longitudinal intermediate parts of the plurality of cavities 34 are exposed to the one surface side in the thickness direction of the rectangular parallelepiped part 33. The cavity exposing recess 40 is positioned in a part where the coupling portions 23 are arranged with the terminals 20 accommodated in the cavities 34. Thus, recessed parts of the terminals 20 between the mating connecting portions 22 and the wire connecting portions 24 can be exposed to outside through the cavity exposing recess 40.

Note that an opening 34a on one end of the cavity 34 is shaped to retain the terminal 20 by making an opening smaller than in the intermediate part (see FIG. 4). The terminal 20 is suppressed from coming out from the opening 34a on the one end of the cavity 34 by the contact of a tip part of the terminal 20 with the opening 34a. Further, the housing body 32 includes resilient locking pieces 32P for locking the mating connecting portions 22 of the terminals 20. The resilient locking piece 32P is an elongated resilient deforming piece resiliently deformable inward and outward of the cavity 34, and a tip part thereof is configured to be lockable to a locking hole 22h formed in the mating connecting portion 22 (see FIG. 4). Such a resilient locking piece 32P is a part, which may be called a locking lance.

The position of the terminal 20 in the cavity 34 is restricted by the contact of the terminal 20 with the opening 34a and the locking of the resilient locking piece 32P to the locking hole 22h formed in the mating connecting portion 22.

The pair of retainer guide grooves 44 are grooves formed in the both side parts of the housing body 32 to extend in a direction intersecting the extension direction of the cavities 34 from both side parts of the cavity exposing recess 40. In this embodiment, the retainer guide groove 44 is a recessed groove extending in a direction orthogonal to both the extension direction of the cavities 34 and the arrangement direction of the plurality of cavities 34 in the side part of the housing body 32. The retainer guide groove 44 does not penetrate through the housing body 32 in the thickness direction.

The pair of locking portions 46 are formed on bottom surfaces 44b of the pair of retainer guide grooves 44. In this embodiment, the locking portion 46 is formed at a position closer to a tip side of the groove 44 than the bottoms of the cavities 34 in the retainer guide groove 44. In this embodiment, the locking portion 46 is a locking protrusion. A surface of the locking portion 46 on the side of the cavity exposing recess 40 is formed into a guide surface gradually increasing a height of the locking portion with distance from the cavity exposing recess 40. A surface of the locking portion 46 on a side opposite to the cavity exposing recess 40 is formed into a contact surface having a larger angle (nearly a right angle) to the side surface of the housing body 32 than the guide surface. In this way, a retainer side portion 56 (to be described later) of the retainer 50 easily rides over the guide surface and is easily kept locked to the contact surface. Note that, separately from the pair of locking portions 46, auxiliary locking portions may be provided on a side closer to the cavity exposing recess 40. The auxiliary locking portions may be, for example, locked to mating locking portions 58 in a state before the mating locking portions 58 are locked to the locking portions 46.

A pair of recessed grooves 48 are formed to extend at least toward one end part of the housing body 32 from positions of the housing body 32 where the pair of locking portions 46 are respectively formed. In this embodiment, the recessed groove 48 is formed to reach the both ends of the housing body 32. The recessed groove 48 is continuously shaped to have a constant width in an extension direction thereof.

Since the recessed groove 48 passes through the position where the locking portion 46 is formed, the retainer guide groove 44 intersects an intermediate part in the extension direction of the recessed groove 48. Thus, an intersecting part of the intermediate part in the extension direction of the recessed groove 48 and the tip part of the retainer guide groove 44 is a part of the recessed groove 48 and also a part of the retainer guide groove 44.

A bottom surface 48b of the recessed groove 48 and the bottom surface 44b of the retainer guide groove 44 are located on the same plane. If an unlocking portion 70 to be described later is slid on the bottom surface 48b of the recessed groove 48, the unlocking portion 70 reaches a part common to the bottom surface 44b of the retainer guide groove 44. In this way, the unlocking portion 70 is easily inserted between the bottom surface 48b of the recessed groove 48 and the retainer side portion 56.

Further, a surface located on a side distant from the cavity exposing recess 40 with respect to the retainer guide groove 44 is a part of a side surface 48a of the recessed groove 48 on the side distant from the cavity exposing recess 40. A tip part of the retainer side portion 56 to be described later is arranged to face the side surface 48a of the recessed groove 48. If the unlocking portion 70 to be described later is slid on the side surface 48a and the bottom surface 48b of the recessed groove 48, the unlocking portion 70 is easily inserted between this side surface of the recessed groove 48 and the tip part of the side portion 56.

The retainer 50 includes a retainer body 52, a pair of the retainer side portions 56 and the mating locking portions 58.

The retainer body 52 is arranged in the cavity exposing recess 40 to hold the terminals 20 in the cavities 34. In this embodiment, the retainer body 52 is in the form of a long plate arrangeable entirely in the cavity exposing recess 40 in the extension direction, i.e. arrangeable in the cavity exposing recess 40 entirely in a width direction of the rectangular parallelepiped part 33. A width of the retainer body 52 is equal to that of the cavity exposing recess 40, and the retainer 52 is accommodated into the cavity exposing recess 40 and positioned in a front-rear direction of the connector housing 30.

An outward facing surface 52f of the retainer body 52 is a flat surface. With the retainer 50 mounted in the housing body 32, a principal surface 32f1 on the one side in the thickness direction of the housing body 32 is located on an extension of the outward facing surface 52f of the retainer body 52. The principal surface 32f1 on the one side in the thickness direction of the housing body 32 is preferably a surface including no protrusion projecting from the outward facing surface 52f of the retainer body 52.

Parts of the inward facing surface of the retainer body 52 facing side walls partitioning between the respective cavities 34 are formed into a shape to face those side walls with as small gaps as possible formed therebetween. In this way, the terminals 20 accommodated in the respective cavities 34 are held in an insulated state.

Parts of the inward facing surface of the retainer body 52 to be arranged in the respective cavities 34 are formed into a shape to protrude into the cavities 34 so as to be able to enter the recesses between the mating connecting portions 22 and the wire connecting portions 24 of the terminals 20 arranged in the cavities 34. The part to be arranged in each cavity 34, out of the inward facing surface of the retainer 52, may be partially recessed more than the other part in conformity with the shape of the terminal 20. The inward facing part of the retainer body 52 projects into the cavity 34 and enters the recess between the mating connecting portion 22 and the wire connecting portion 24 of the terminal 20 in this cavity 34, whereby the terminal 20 is held at a fixed position in the cavity 34. In this state, the retainer body 52 is fit in the cavity exposing recess 40. If an attempt is made to move the terminal 20 in the extension direction thereof, this force is received by both front and rear surfaces of the cavity exposing recess 40 via the retainer body 52.

Slits 52s extending along the extension direction of the cavities are formed in the inward facing part of the retainer body 52. The retainer body 52 includes partially thinned portions 52p outside the slits 52s.

In this embodiment, the retainer body 52 is formed with lightening holes 52h penetrating through an intermediate part in the thickness direction of the retainer body 52. The lightening hole 52h is the form of a flat hole in a region extending over the first and second cavities 34 from an end thereof. The elongated slit 52s is formed in a part of the retainer body 52 extending from each lightening hole 52h to either one of the cavities 34. A part of the retainer body 52 located outside the slit 52s and surrounding each lightening hole 52h is the thinned portion 52p.

An inward facing surface of the thinned portion 52p is located outward of the principal surface 32f1 of the housing body 32 in an initial stage of lifting the retainer body 52 from the cavity exposing recess 40. Further, a part interfering when a disassembly tool is arranged is not present on a forward extension of the inner facing surface of the thinned portion 52p. Thus, an operation of removing the retainer 50 from the connector housing 30, utilizing the thinned portions 52p, is easily performed.

Further, at least one edge of the part of the retainer body 52 formed with the thinned portion 52p is partially recessed in an extension direction of the retainer guide groove 44 (same direction as the extension direction of the cavities 34), thereby forming recesses 52g. In this embodiment, the edge of the retainer body 52 on the tip side of the terminals 20 (side opposite to the side where the wires 28 extend out) is recessed to form the recesses 52g. Although the recess 52g is recessed over the entire lightening portion 52h in the width direction in this embodiment, the recess 52g may be formed only in a part corresponding to a width of the thinned portion 52P corresponding to a width of the slit 52s.

The pair of retainer side portions 56 are formed to extend along the pair of retainer guide grooves 44 from both side parts of the retainer body 52. In this embodiment, the retainer side portion 56 is in the form of a rectangular plate having a constant width. A width of the retainer side portion 56 is set to be equal to that of the retainer side portion 56 to such an extent that the retainer side portion 56 is accommodated into the retainer guide groove 44. In this embodiment, the width of the retainer side portion 56 is larger than that of the retainer body 52 in a front-rear direction of the housing body 32.

A length of the retainer side portion 56 is set in such a size that a tip part of the retainer side portion 56 reaches a position just before (e.g. within 2 mm, preferably within 1 mm before) the side surface 48a of the recessed groove 48 with the retainer body 52 arranged in the cavity exposing recess 40.

The inward facing surface of the tip part of the retainer side portion 56 is formed into a guide surface 56g extending outward toward a tip side. When the retainer side portion 56 is moved in and along the retainer guide groove 44, the guide surface 56g contacts the locking portion 46, whereby the retainer side portion 56 is easily resiliently deformable outward.

Since the tip part of the retainer side portion 56 reaches a position just before the side surface 48a of the recessed groove 48, a state where a surrounding member contacts the guide surface 56g and inadvertently deforms the retainer side portion 56 outward hardly occurs.

The pair of retainer side portions 56 are respectively formed with a pair of the mating locking portions 58 lockable to the locking portions 46. In this embodiment, the mating locking portion 58 is a recess to be locked to the locking portion 46, which is a protrusion. More specifically, the mating locking portion 58 in the form of a recessed groove extending along an extension direction of the retainer side portion 56 is formed in the inward facing surface of the retainer side portion 56. A tip part of the mating locking portion 58 reaches a position just before the tip part of the retainer side portion 56. In the tip part of the mating locking portion 58, a surface facing the retainer body 52 is a locking surface 58f lockable to the locking portion 46.

Note that the mating locking portions 58 extend toward the base ends of the pair of retainer side portions 56 and penetrate through the retainer body 52. In this way, the groove-shaped mating locking portions 58 are easily molded. It is not essential that the mating locking portions 58 reach the base ends of the pair of retainer side portions 56.

The retainer side portion 56 can be locked to the locking portion 46 while being arranged in the retainer guide groove 44. With the retainer 50 mounted in the connector housing 30, both outward facing side surfaces 32f2 of the housing body 32 are located on extensions of the outward facing surfaces 56f of the retainer side portions 56. The side surface 32f2 of the housing body 22 is preferably a surface including no protrusion projecting from the outward facing surface 56f of the retainer side portion 56.

In this connector 10, the terminals 20 are held in the cavities 34 by mounting the retainer 50 into the connector housing 30 with the terminals 20 inserted in the cavities 34. In the mounted state of the retainer 50, the locking portions 46 of the connector housing 30 are locked to the mating locking portions 58 of the retainer 50. Further, the inward facing part of the retainer body 52 is inserted in the cavities 34 and the recesses between the mating connecting portions 22 and the wire connecting portions 24 of the terminals 20 in the cavities 34.

Towards decarbonization, it is requested to improve recyclability for in-vehicle components to be installed in a vehicle. The connector 10 is an example of a component applicable as an in-vehicle component. It is requested for the connector 10 to easily and quickly disassemble the terminals 20 made of metal and the connector housing 30 made of resin for the improvement of recyclability.

It is requested for the connector 10 to lift the retainer 50 from the connector housing 30 and enable a hooked state of the retainer body 52 to the terminals 20 in the cavities 34 to be quickly released. This is because the terminals 20 can be pulled out from the cavities 34 and the connector 10 can be easily disassembled, such as by pulling the wires 28, if the hooked state of the retainer 50 to the terminals 20 can be released. Note that it is sufficient to disassemble the connector 10 at least into the connector housing 30, which is a resin part, and the terminals 20, and it is not essential that the connector housing 30 can be disassembled into the housing body 32 and the retainer 50.

### <Connector Disassembly Tool>

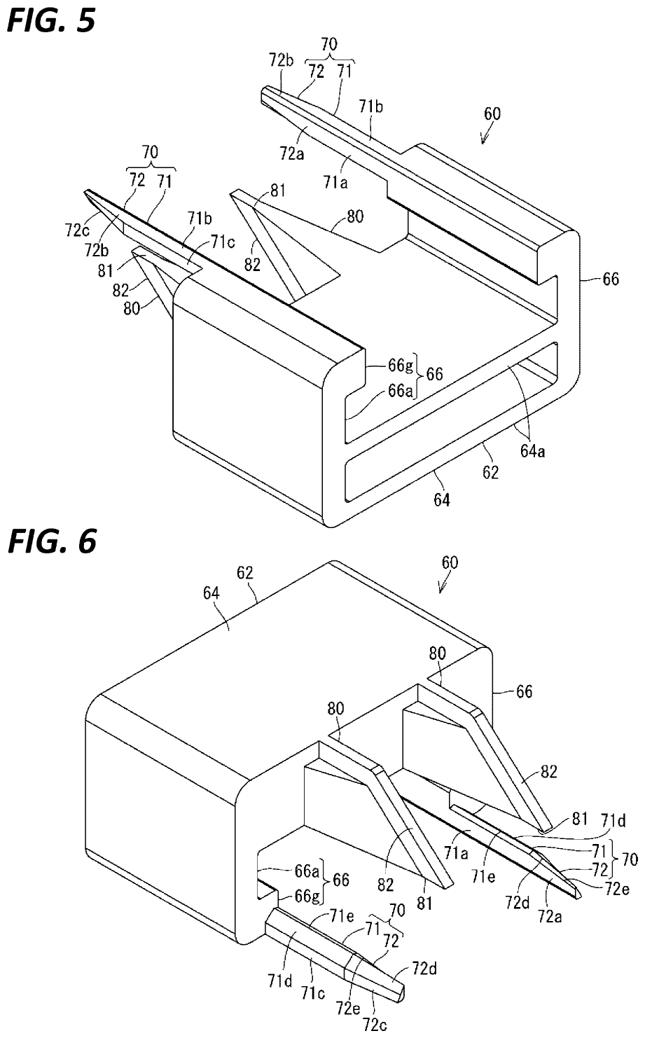

A connector disassembly tool 60 applicable to the disassembly of the connector 10 is described below. FIGS. 5 and 6 are perspective views showing the connector disassembly tool 60.

The connector disassembly tool 60 is provided with a pair of the unlocking portions 70 and a disassembly tool body 62. The connector disassembly tool 60 may be, for example, a resin molded article, a tool made of metal or a composite component of resin and metal.

The pair of unlocking portions 70 are formed into a long shape. A tip part of the unlocking portion 70 is formed into a shape gradually thinned toward a tip to be insertable between the retainer side portion 56 and the housing body 32. The disassembly tool body 62 supports the pair of unlocking portions 70 in parallel. The pair of unlocking portions 70 are kept in a parallel state corresponding to an interval between the pair of recessed grooves 48 by the disassembly tool body 62.

More specifically, the unlocking portion 70 is formed into a long shape having such a thickness as to be arrangeable in the recessed groove 48 with an extension direction thereof extending along the extension direction of the recessed groove 48. The unlocking portion 70 includes a body portion 71 and a tip portion 72. The body portion 71 is a part having the same cross-sectional shape over the entire length thereof. A base end part of the body portion 71 is supported on the disassembly tool body 62. The tip portion 72 is a part linearly connected to the tip of the body portion 71 and gradually thinned.

The body portion 71 has a first contact surface 71a and a second contact surface 71b perpendicular and adjacent to each other. The first contact surface 71a can contact the bottom surface 48b of the recessed groove 48 and the second contact surface 71b can contact the side surface 48a of the recessed groove 48.

The body portion 71 has an outward facing surface 71c facing a side opposite to the first contact surface 71a and an inclined surface 71d gradually inclined toward the first contact surface 71a from the outward facing surface 71c toward a side opposite to the second contact surface 71b. The first contact surface 71a and the outward facing surface 71c are parallel to each other. In this embodiment, the first contact surface 71a and the inclined surface 71d are connected via a coupling surface 71e. Thus, the body portion 71 is a long member surrounded by the first contact surface 71a, the second contact surface 71b, the outward facing surface 71c, the inclined surface 71d and the coupling surface 71e.

The tip portion 72 has a first contact surface 72a, a second contact surface 72b, an outward facing surface 72c, an inclined surface 72d and a coupling surface 72e.

The first contact surface 72a is located on an extension of the first contact surface 71a, and the second contact surface 72b is located on an extension of the second contact surface 71b. Thus, the unlocking portion 70 can be moved along the recessed groove 48 with the first contact surfaces 71a, 72a held in contact with the bottom surface 48b of the recessed groove 48 and the second contact surfaces 71b, 72b held in contact with the side surface 48a of the recessed groove 48. The first and second contact surfaces 72a, 72b are examples of contact receiving surfaces to be held in contact with the bottom surface 48b and the side surface 48a of the recessed groove 48 when the unlocking portion 70 moves in the recessed groove 48.

The outward facing surface 72c is formed into a shape to gradually approach the first contact surface 72a from the tip edge of the outward facing surface 71c toward a tip side. In this embodiment, a part of the outward facing surface 72c near the tip is formed into a shape to gradually approach the first contact surface 72a toward a side opposite to the second contact surface 72b.

The inclined surface 72d is formed into a shape to gradually approach the first and second contact surfaces 72a, 72b from the tip edge of the inclined surface 71d toward the tip side.

The outward facing surface 72c and the inclined surface 72d are examples of separating/lifting surfaces located on a side opposite to the contact receiving surfaces including the first and second contact surfaces 72a, 72b and gradually separating from the bottom surface 48b and the side surface 48a of the recessed groove 48 toward a base end side.

The coupling surface 72e is formed into a shape to couple the first contact surface 72a and the inclined surface 72d.

Note that each of the above surfaces may be a flat surface or a curved surface. Further, rounded parts or chamfered parts may be interposed between the respective surfaces.

The tip part of the unlocking portion 70 may be pointed, flat or rounded. In this embodiment, the tip part of the unlocking portion 70 is formed into a flat surface.

The disassembly tool body 62 is provided with a pair of side portions 66 and a coupling portion 64.

The pair of side portions 66 are configured such that guide protrusions 66g are formed on tip parts of elongated plate-like parts 66a. The plate-like part 66a is in the form of a plate arrangeable outside the side surface 32f2 at a position closer to the cavity exposing recess 40 than the recessed groove 48 of the housing body 32. The elongated guide protrusion 66g projects on an inner side of the tip part of the plate-like part 66a. The guide protrusion 66g is formed into a rectangular parallelepiped shape having a width corresponding to the width of the recessed groove 48. By arranging the guide protrusions 66g in the recessed grooves 48, the connector disassembly tool 60 is guided to move along the recessed grooves 48.

The unlocking portion 70 projects on an inner side of a tip part of each of the pair of side portions 66. The unlocking portion 70 projects along an extension direction of the guide protrusion 66g. After the first contact surfaces 71a, 72a and the second contact surfaces 71b, 72b of the unlocking portion 70 contact the bottom surface 48b and the side surface 48a of the recessed groove 48 and slide, the guide protrusion 66g can enter the recessed groove 48.

The coupling portion 64 couples the base ends of the pair of side portions 66 and keeps the pair of side portions 66 in parallel. In this way, the pair of side portions 66 are spaced apart by an interval corresponding to the width of the housing body 32.

The coupling portion 64 includes a pair of plate portions 64a arranged in parallel at an interval. Each of the pair of plate portions 64a keeps the pair of side portions 66 in parallel. Although one opening between the pair of side portions 64a is closed, this is not essential.

With the guide protrusion 66g arranged in the recessed groove 48, the inward facing surface of the coupling portion 64 is arranged to face the principal surface 32f1 of the connector housing 30 of the housing body 32. As described above, the inward facing surfaces of the side portions 66 are also arranged to face the side surfaces 32f2 of the connector housing 30. The housing body 32 includes parts projecting from the principal surface 32f1 and the side surfaces 32f2.

Thus, the disassembly tool body 62 is shaped to surround at least a part of the periphery of the housing body 32 while avoiding interference with the housing body 32 when the pair of unlocking portions 70 move along the pair of recessed grooves 48.

If the housing body 32 includes a part projecting from the principal surface 32f1 or the side surface 32f2, an inward facing part of the disassembly tool body may include a recess for avoiding this projecting part.

Note that the housing body 32 may have an annular shape to surround the entire periphery of the housing body 32, e.g. a rectangular frame shape.

In this embodiment, the connector disassembly tool 60 is further provided with additional lifting portions 80.

The additional lifting portions 80 are supported by the disassembly tool body 62 to extend in the same direction as the extension direction of the pair of unlocking portions 70. The additional lifting portion 80 is in the form of a plate orthogonal to an arrangement direction of the pair of unlocking portions 70. Edges of the additional lifting portions 80 on the side of the pair of unlocking portions 70 are formed into contact edges 81 configured to contact the principal surface 32f1 of the housing body 32 when the pair of unlocking portions 70 move along the pair of recessed grooves 48.

The additional lifting portions 80 have lifting edges 82 extending toward the pair of unlocking portions 70 toward tip sides. The lifting edges 82 can also be said to extend in a direction separating from the pair of unlocking portions 70 from the tips of the contact edges 81 toward the base ends of the additional lifting portions 80.

In this embodiment, projecting lengths of the pair of unlocking portions 70 are equal to those of the additional lifting portions 80. In conformity with the shape of the retainer 50, the projecting lengths of the pair of unlocking portions 70 and the additional lifting portions 80 may be so set that the pair of unlocking portions 70 can contact the retainer 50 earlier than the additional lifting portions 80.

The additional lifting portions 80 can enter between the principal surface 32f1 of the housing body 32 and the retainer body 52 with the tip portions 72 of the pair of unlocking portions 70 inserted between the retainer side portions 56 and the side surfaces 32f2 of the housing body 32. At this time, the contact edges 81 contact the principal surface 32f1 of the housing body 32 and the lifting edges 82 contact the inward facing surface of the retainer body 52. As the additional lifting portions 80 enter between the principal surface 32f1 of the housing body 32 and the retainer body 52, the lifting edges 82 can move the retainer body 52 in a direction separating from the cavity exposing recess 40.

### <Disassembly Operation of Connector>

An operation example of disassembling the connector 10 using the connector disassembly tool 60 is described.

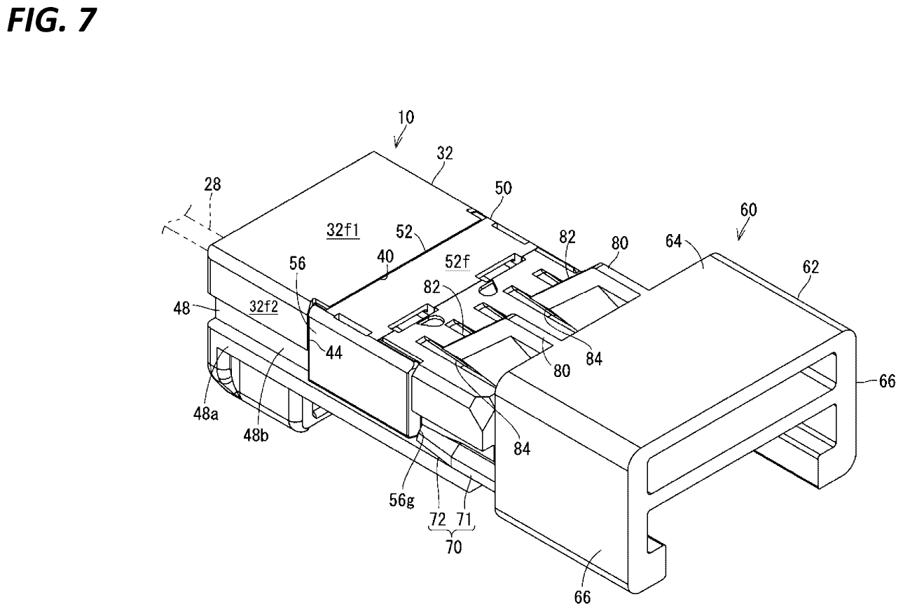

First, as shown in FIG. 7, the connector 10 to be disassembled is prepared. The terminal 20 is accommodated in each cavity 34 of the connector 10. It is thought that the retainer body 52 is inserted in the recesses between the mating connecting portions 22 and the wire connecting portions 24 and the resilient locking pieces 32P are hooked to the locking holes 22h of the mating connecting portions 22. The wire 28 having the terminal 20 crimped to the end part thereof extends out to the rear end side of the housing body 32 from the cavity 34.

The pair of unlocking portions 70 are inserted into the pair of recessed grooves 48 from the front side of the housing body 32, the first contact surfaces 71a, 72a of the unlocking portions 70 are brought into contact with the bottom surfaces 48b of the recessed grooves 48 and the second contact surfaces 71b, 72b are brought into contact with the side surfaces 48a of the recessed grooves 48. Further, the contact edges 81 of the additional lifting portions 80 are brought into contact with the principal surface 32f1 of the housing body 32.

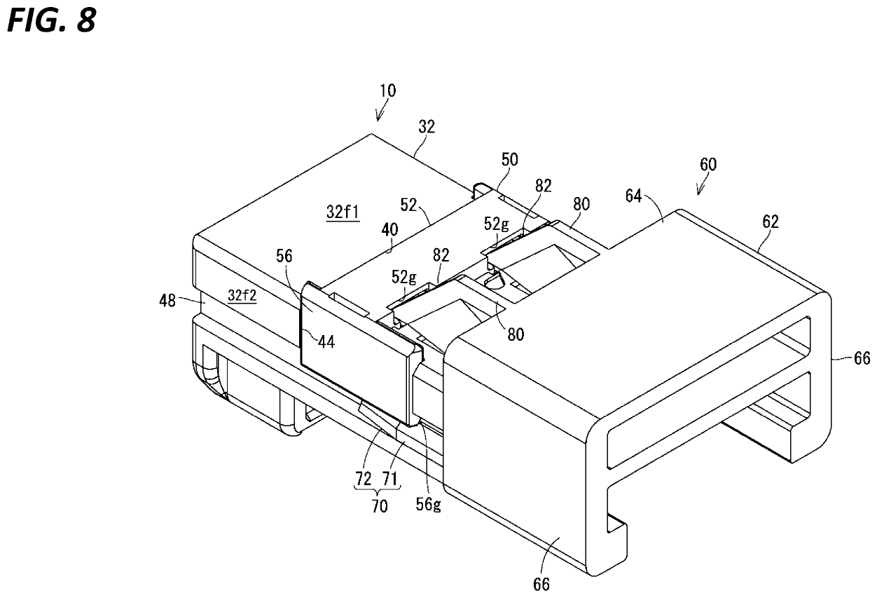

The pair of unlocking portions 70 are further pushed into the pair of recessed grooves 48 while each of the above contact states is maintained. Then, the tip parts of the unlocking portions 70 enter between the side surfaces 32f2 of the housing body 32 and the retainer side portions 56 as shown in FIG. 8.

More specifically, out of the tip portion 72 of the unlocking portion 70, the outward facing surface 72c and the inclined surface 72d constituting the separating/lifting surfaces enter a gap between the bottom surface 48b and the side surface 48a of the recessed groove 48 and the tip part of the retainer side portion 56. Since the outward facing surface 72c and the inclined surface 72d constituting the separating/lifting surfaces are shaped to extend toward the bottom surface 48b and the side surface 48a of the recessed groove 48 toward the tip side, the tip part can easily enter the gap between the bottom surface 48b and the side surface 48a of the recessed groove 48 and the tip part of the retainer side portion 56. Further, since the guide surface 56g is formed on the tip part of the retainer side portion 56, the gap between the bottom surface 48b and the side surface 48a of the recessed groove 48 and the tip part of the retainer side portion 56 can be increased by this guide surface. Also by this, the tip part of the unlocking portion 70 can easily enter the gap between bottom surface 48b and the side surface 48a of the recessed groove 48 and the tip part of the retainer side portion 56.

If the tip portion 72 and the body portion 71 of the unlocking portion 70 enter between the side surface 32f2 of the housing body 32 and the retainer side portion 56, the tip part of the retainer side portion 56 is resiliently deformed in a direction separating from the side surface 32f2. In this way, the locked state of the locking portion 46 and the mating locking portion 58 is released. In this state, the tip portion 72 and the body portion 71 of the unlocking portion 70 can move the retainer side portion 56 toward the retainer body 52. In this way, the retainer body 52 moves in the direction separating from the cavity exposing recess 40.

It is preferred to release the state where the retainer body 52 is inserted in the recesses between the mating connecting portions 22 and the wire connecting portions 24, i.e. release a state of holding the terminals 20 by the retainer 50, with the unlocking portions 70 inserted in the gaps to the tip parts of the retainer side portions 56.

If the state of holding the terminals 20 by the retainer 50 is released, the terminals 20 are held by the resilient locking pieces 32P. The locked state by the resilient locking piece 32P is supposed to be released by pulling the wire 28 with a large force. If the reuse of the connector housing 30 is not supposed, the resilient locking pieces 32P may be broken.

As the pair of unlocking portions 70 are pushed into the pair of recessed grooves 48, the tips of the additional lifting portions 80 reach the retainer body 52 and the lifting edges 82 start to contact the retainer body 52 from inside. In this embodiment, the additional lifting portions 80 are located in the thinned portions 52p (i.e. positions where the slits 52s are formed) in the extension direction of the retainer body 52. Thus, the lifting edges 82 contact the thinned portions 52p. The inward facing surfaces of the thinned portions 52p are arranged at positions lifted from the principal surface 32f1 of the housing body 32 earlier than the inward facing surfaces of the other parts of the retainer body 52. Thus, the retainer body 52 can be lifted up by the additional lifting portions 80 in an initial stage where a lifting amount of the retainer body 52 is small.

Further, the recesses 52g are formed in the parts of the retainer body 52 where the thinned portions 52p are formed. Positions or timings at which the tips of the additional lifting portions 80 start to contact the retainer body 52 can be adjusted by recess lengths of the recesses 52g.

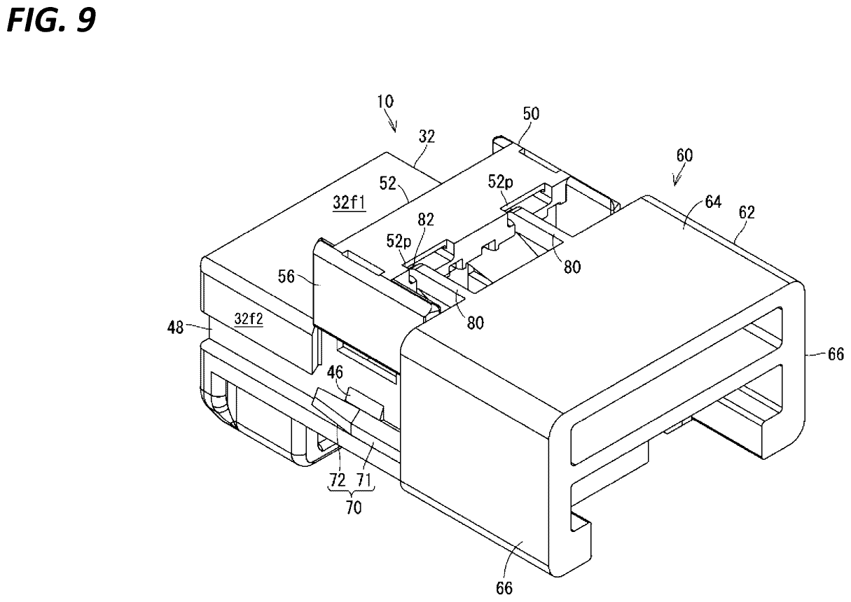

As shown in FIG. 9, as the retainer 50 is further pushed, the lifting edges 82 further lift up the retainer body 52, the retainer body 52 comes out from the cavity exposing recess 40 and the retainer side portions 56 come out from the retainer guide grooves 44. In this way, the retainer 50 is separated from the housing body 32.

The disassembly tool body 62 surrounds at least a part of the periphery of the housing body 32 while avoiding interference with the housing body 32. Thus, if the pair of locking portions 70 pass through the recessed grooves 48, the disassembly tool body 62 can pass through the periphery of the housing body 32 in the same direction. That is, if the connector 10 is pulled to pass through the inside of the connector disassembly tool 60 with the pair of unlocking portions 70 guided by the pair of recessed grooves 48, the retainer 50 is disassembled from the housing body 32. At this time, the retainer 50 is pushed by the disassembly tool body 62 and more reliably separated from the housing body 32.

After the retainer 50 is disassembled from the housing body 32, the terminals 20 may be pulled out from the cavities 34 by pulling the wires 28.

Note that the connector disassembly tool 60 can deform the retainer side portions 56 in the directions away from the side surfaces 32f2 of the connector housing 30 also when the connector 10 is not formed with the recessed grooves 48. Also in this case, the connector disassembly tool 60 can be utilized as a disassembly tool for disassembling the terminals 20 from the connector housing 30.

### Effects, Etc.

According to the connector 10 configured as described above, the gaps between the pair of retainer side portions 56 and the side surfaces 32f2 of the housing body 32 are easily accessible, utilizing spaces in the pair of recessed grooves 48. Thus, utilizing the pair of recessed grooves 48, the locking of the locking portions 46 and the mating locking portions 58 is easily released by moving the pair of retainer side portions 56 in the directions separating from the side surfaces 32f2 of the housing body 32, and the retainer body 52 is easily moved in the direction separating from the cavity exposing recess 40. In this way, the state of holding the terminals 20 by the retainer 50 can be easily released.

In this way, the terminals 20 made of metal and the connector housing 30 made of resin can be easily and quickly disassembled, for example, in recycling the connector, which is an in-vehicle component, towards decarbonization.

Further, since the pair of recessed grooves 48 are respectively grooves extending from the positions of the housing body 32 where the pair of locking portions 46 are formed toward the both ends of the housing body 32, the state of holding the terminals 20 by the retainer 50 can be easily released, utilizing the recessed grooves 48. For example, after the pair of unlocking portions 70 are inserted between the retainer side portions 56 and the side surfaces 32f2 of the housing body 32, the pair of unlocking portions 70 can be directly pulled out from the pair of recessed grooves 48. In this way, the retainer 50 can be moved by the additional lifting portions 80 and the retainer 50 can be pushed away by the disassembly tool body 62.

Further, since the retainer body 52 includes the partially thinned portions 52p, the inward facing surfaces of the thinned portions 52p are easily located more outward than the principal surface 32f1 of the housing body 32 even if a moving distance of the retainer 52 in the direction separating from the cavity exposing recess 40 is short. In this way, the retainer 52 is more easily moved in the direction separating from the cavity exposing recess 40 from a state where the retainer 50 is slightly lifted.

Further, since at least one edge of the part of the retainer body 52 where the thinned portion 52p is formed is partially recessed to form the recess 52g, it is possible to adjust a contact timing of the connector disassembly tool 60 with at least the one edge of the part of the retainer body 52 where the thinned portion 52p is formed, for example, when the retainer 50 is removed by moving the connector disassembly tool 60 along the retainer guide grooves 44.

In this way, for example, if types of connectors different in length or types of connectors different in retainer position are present, the same connector disassembly tool 60 is easily applied as a disassembly tool for the different types of connectors by adjusting the recessed amounts of the recesses.

Further, since the housing body 32 has the principal surface 32f1 located on the extension of the outward facing surface of the retainer body 52 and the pair of side surfaces 32f2 located on the extensions of the outward facing surfaces of the retainer side portions 56 in the mounted state of the retainer 50, the connector disassembly tool 60 is easily handled outside the principal surface 32f1 and the pair of side surfaces 32f2. For example, an operation of removing the retainer 50 can be so performed by the connector disassembly tool 60 that the connector housing 30 passes through the inside of the connector disassembly tool 60.

Further, since the housing body 32 includes only the plurality of cavities 34 arranged in a row, the retainer 50 is easily separated from the housing body 32.

Further, according to this connector disassembly tool 60, each of the pair of unlocking portions 70 includes the tip portion 72 gradually thinned toward the tip to be insertable between the retainer 50 and the side part of the housing body 32. Thus, the tip portions 72 of the pair of unlocking portions 70 can be inserted between the retainer 50 and the side parts of the housing body 32 by moving the pair of unlocking portions 70 along the both side parts of the housing body 32. In this way, the locked state of the retainer 50 to the housing body 32 can be released and the state of holding the terminals 20 by the retainer 50 can be released.

Further, the tip portion 72 of the unlocking portion 70 has the first and second contact surfaces 72a, 72b serving as the contact receiving surfaces to be brought into contact with the bottom surface 48b and one side surface 48a of the recessed groove 48, and the outward facing surface 72c and the inclined surface 72d serving as the separating/lifting surfaces located on the sides opposite to the contact receiving surfaces and gradually separating from the bottom surface 48b and the side surface 48a of the recessed groove 48 toward the base end side. Thus, the retainer 50 can be moved in directions separating from the bottom surfaces 48b and the side surfaces 48a of the recessed grooves 48 by the separating/lifting surfaces by moving the unlocking portions 70 in the recessed grooves 48. In this way, the locked state of the retainer 50 to the housing body 32 can be released, the retainer 50 can be moved in the direction separating from the housing body 32 and the state of holding the terminals 20 by the retainer 50 can be released.

Further, since the disassembly tool body 62 includes the additional lifting portions 80, the retainer 50 lifted by the unlocking portions 70 can be further lifted up in the direction separating from the cavity exposing recess 40 by the additional lifting portions 80 and the connector 10 is more easily disassembled.

Further, since the disassembly tool body 62 is formed into a shape to surround at least a part of the periphery of the housing body 32 while avoiding interference with the housing body 32 when the pair of unlocking portions 70 move along the pair of recessed grooves 48, the pair of unlocking portions 70 are easily moved along the pair of recessed grooves 48. If the recessed grooves 48 penetrate between the both ends of the housing body 32, the pair of unlocking portions 70 can be set to pass through the pair of recessed grooves 48 and the disassembly operation of the connector 10 is easily performed.

### Modifications

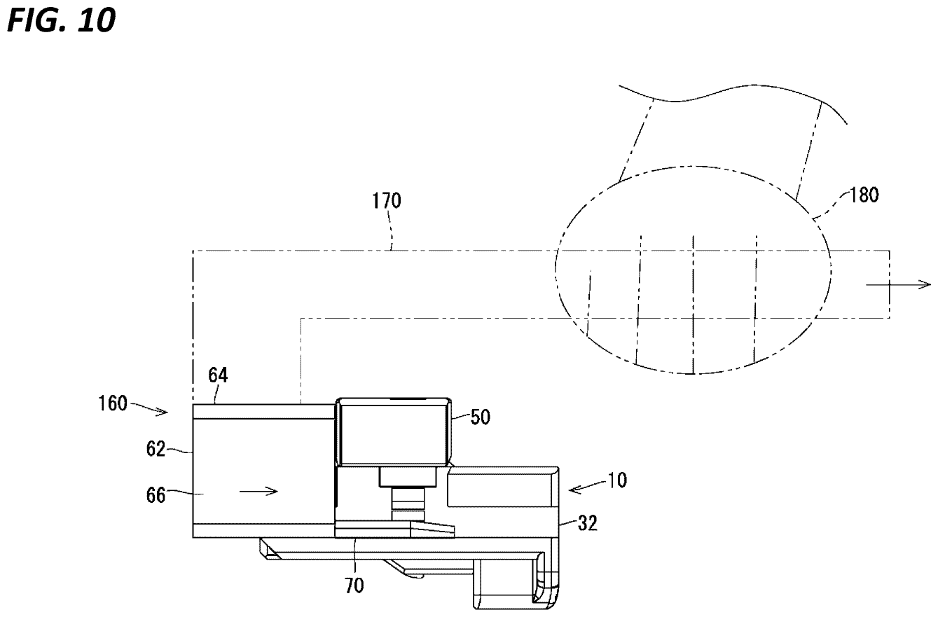

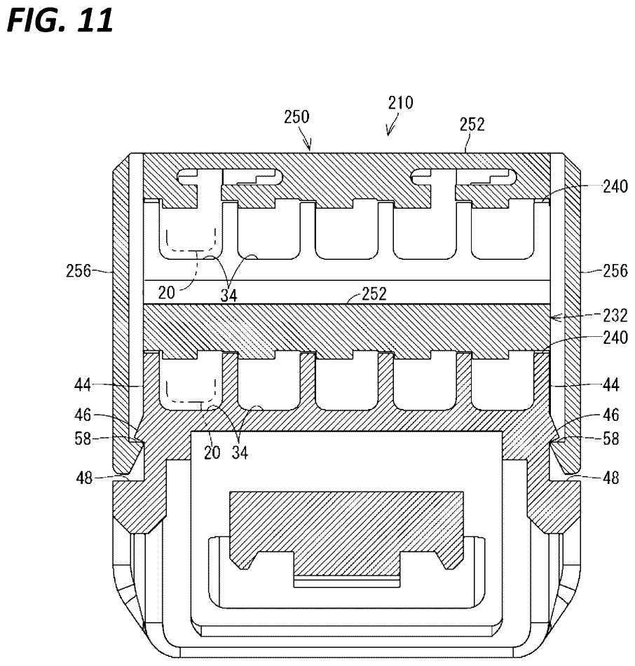

Like a connector disassembly tool 160 according to a modification shown in FIG. 10, a grip portion 170 projecting from a disassembly tool body 62 may be provided. The grip portion 170 is a part for holding the connector disassembly tool 160 at a fixed position or receiving a force for moving the connector 10 by projecting from the disassembly tool body 62. The grip portion 170 may be an elongated bar-like handle easily gripped by a hand 180 of a worker. The grip portion 170 may extend in any direction from the disassembly tool body 62. In FIG. 10, the grip portion 170 projects from a coupling portion 64 in the same direction as unlocking portions 70 with respect to the disassembly tool body 62.

A grip portion may be a plate-like, rectangular or bar-like projection projecting from the outer surface of a side portion 66. A grip portion needs not be of a size grippable by hand. For example, a grip portion may be a projection having such a surface capable of receiving a force of fingers.

Conceivably, the connector 10 itself is small (e.g. a width of about 10 mm to 15 mm) and, accordingly, the disassembly tool body 62 itself is also small. In such a case, by providing the connector disassembly tool 160 with the grip portion 170, the connector disassembly tool 160 is easily moved with respect to the connector 10. In this way, the disassembly operation of the connector 10 can be easily performed.

Like a connector 210 according to a modification shown in FIG. 11, a housing body 232 corresponding to the housing body 32 may include a plurality of cavities 34 extending from one side toward the other side of a retainer body 252 corresponding to the retainer body 52 and arranged in a plurality of rows at positions different in a direction along a retainer guide grooves 44.

In this case, the housing body 232 includes a plurality of cavity exposing recesses 240 corresponding to the cavity exposing recess 40 in correspondence with the respective rows of the plurality of cavities. A retainer 250 corresponding to the retainer includes a plurality of retainer bodies 252 in correspondence with the respective rows of the plurality of cavities 34.

Also in this case, a locked state of the retainer 250 to the housing body 232 can be easily released as in the above embodiment since the connector 210 includes recessed grooves 48.

Further, by making the side portions 66 of the connector disassembly tool 60 longer, the unlocking portions 70 can be easily inserted between retainer side portions 256 corresponding to the retainer side portions 56 and side portions of the housing body 232 and the locked state of the retainer 250 to the housing body 232 can be easily released as in the above embodiment.

In this way, a state of holding the terminals 20 by the retainer body 252 can be collectively released in each row of the plurality of cavities 34.

Note that, in the case of this modification, after the locked state of the retainer 250 to the housing body 232 is released, the terminals 20 may be pulled out and, thereafter, the retainer 250 may be separated from the housing body 232. Note that the retainer 250 may not be separated from the housing body 232.

Note that the respective components described in the above embodiment and each modification can be appropriately combined as long as those do not contradict each other.

### LIST OF REFERENCE NUMERALS

10, 310 connector
20 terminal
22 mating connecting portion
22h locking hole
23 coupling portion
24 wire connecting portion
28 wire
30 connector housing
32, 232 housing body
32P resilient locking piece
32f1 principal surface of housing body
32f2 side surface of housing body
33 rectangular parallelepiped part
34 cavity
34a opening of cavity
35 connector connecting locking piece
36 operating portion
37 surrounding portion
40, 240 cavity exposing recess
44 retainer guide groove
46 locking portion
48 recessed groove
48a side surface (one side surface) of recessed groove
48b bottom surface of recessed groove
50, 250 retainer
52, 252 retainer body
52f outward facing surface
52g recess
52h lightening hole
52p thinned portion
52s slit
56, 256 retainer side portion
56f outward facing surface
56g guide surface
58 mating locking portion
58f locking surface
60, 160 connector disassembly tool
62 disassembly tool body
64 coupling portion
64a plate portion
66 side portion
66a plate-like part
66g guide protrusion
70 unlocking portion
71 body portion
71a first contact surface
72a first contact surface (contact receiving surface)
71b second contact surface
72b second contact surface (contact receiving surface)
71c outward facing surface
72c outward facing surface (separating/lifting surface)
71d inclined surface
72d inclined surface (separating/lifting surface)
71e, 72e coupling surface
72 tip portion
80 additional lifting portion
81 contact edge
82 lifting edge
170 grip portion
180 hand of worker

1. A connector, comprising:
a terminal; and
a connector housing including a housing body having a cavity extending from one end toward the other end and a retainer to be removably mounted into the housing body, the terminal being accommodated into the cavity,
the housing body including a cavity exposing recess for exposing an intermediate part in an extension direction of the cavity to outside, a pair of retainer guide grooves formed in both side parts of the housing body to extend in a direction intersecting the extension direction of the cavity from both side parts of the cavity exposing recess, and a pair of locking portions respectively formed on bottom surfaces of the pair of retainer guide grooves,
the retainer including a retainer body to be arranged in the cavity exposing recess to hold the terminal in the cavity, a pair of retainer side portions extending from both side parts of the retainer body along the pair of retainer guide grooves and a pair of mating locking portions respectively formed on the pair of retainer side portions and lockable to the locking portions, and
a pair of recessed grooves being formed to extend from positions of the housing body where the pair of locking portions are respectively formed toward at least one end of the housing body.

2. The connector of claim 1, wherein the pair of recessed grooves are respectively grooves extending from the positions of the housing body where the pair of locking portions are respectively formed toward both ends of the housing body.

3. The connector of claim 1, wherein:
a slit extending along the extension direction of the cavity is formed in an inward facing part of the retainer body, and
the retainer body includes a partially thinned portion outside the slit.

4. The connector of claim 3, wherein at least one edge of a part of the retainer body where the thinned portion is formed is partially recessed in an extension direction of the retainer guide grooves.

5. The connector of claim 1, wherein the housing body has a principal surface located on an extension of an outward facing surface of the retainer body and a pair of side surfaces located on extensions of outward facing surfaces of the pair of retainer side portions in a mounted state of the retainer.

6. The connector of claim 1, wherein the housing body includes a plurality of cavities arranged in a row extending from one side toward the other side of the retainer body.

7. The connector of claim 1, wherein:
the housing body includes a plurality of cavities arranged in a plurality of rows extending from one side toward the other side of the retainer body at positions different in a direction along the retainer guide grooves,
the housing body includes a plurality of the cavity exposing recesses in correspondence with the respective rows of the plurality of cavities, and
the retainer includes a plurality of the retainer bodies in correspondence with the respective rows of the plurality of cavities.

8. A connector disassembly tool for releasing a locked state of a retainer to a housing body, comprising:
a pair of unlocking portions formed into a long shape; and
a disassembly tool body for supporting the pair of unlocking portions such that the pair of unlocking portions are kept in a parallel state corresponding to locking parts of both side parts of the housing body and the retainer,
each of the pair of unlocking portions including a tip portion gradually thinned toward a tip to be insertable between the retainer and the side part of the housing body.

9. The connector disassembly tool of claim 8, wherein the tip portion of the unlocking portion has a contact receiving surface to be held in contact with a bottom surface and one side surface of a recessed groove formed in the side part of the housing body when the unlocking portion moves along the side part of the housing body and a separating/lifting surface located on a side opposite to the contact receiving surface and gradually separating from the bottom surface and the one side surface of the recessed groove toward a base end side.

10. The connector disassembly tool of claim 8, further comprising an additional lifting portion supported by the disassembly tool body to extend in the same direction as an extension direction of the pair of unlocking portions, wherein:
the additional lifting portion enters between the retainer and the housing body to move the retainer in a direction separating from the housing body at a position between the pair of unlocking portions with the tip portions of the pair of unlocking portions inserted between the retainer and the side parts of the housing body.

11. The connector disassembly tool of claim 8, wherein the disassembly tool body is formed into a shape to surround at least a part of a periphery of the housing body while avoiding interference with the housing body when the pair of unlocking portions move along a pair of recessed grooves formed in the both side parts of the housing body.

12. The connector disassembly tool of claim 8, further comprising a grip portion projecting from the disassembly tool body.
